(19) United States
(12) Patent Application Publication
(10) Pub. No.: US 2024/0316636 A1
(43) Pub. Date: Sep. 26, 2024

(54) METHOD OF JOINING TWO DISSIMILAR ALLOYS AND COMPOSITE ARTICLES INCLUDING THE SAME

(71) Applicant: UT-Battelle, LLC, Oak Ridge, TN (US)

(72) Inventors: Soumya Nag, Oak Ridge, TN (US); James Haley, Oak Ridge, TN (US); Brian Jordan, Oak Ridge, TN (US)

(21) Appl. No.: 18/606,129

(22) Filed: Mar. 15, 2024

Related U.S. Application Data
(60) Provisional application No. 63/453,632, filed on Mar. 21, 2023.

(51) Int. Cl. B22F 7/02; B22F 10/28; B33Y 10/00; B33Y 80/00

(52) U.S. Cl. CPC B22F 7/02; B22F 10/28; B33Y 10/00; B33Y 80/00; B22F 2301/15; B22F 2301/20; B22F 2301/205; B22F 2998/10

(57) ABSTRACT

A composite article is provided. The composite article includes a first portion comprising a first alloy having a first composition, and a second portion comprising a second alloy having a second composition. The second composition is different than the first composition. A transition portion joins the first portion to the second portion, and comprises a transition material having a composition that is different than both the first composition of the first alloy and the second composition of the second alloy. The transition portion includes only the transition material or a compositional gradient. The first alloy may be a high-strength material, and the second alloy may be an extreme-temperature material, or vice versa. The transition material may be a Ti-based alloy, a refractory element, or a refractory alloy other than a Nb-based alloy. A method of fabricating the composite article and a method of joining two dissimilar alloys are also provided.

### CROSS-REFERENCE TO RELATED APPLICATIONS

This application claims the benefit of U.S. Provisional Application No. 63/453,632, filed Mar. 21, 2023, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to methods of joining alloys for the fabrication of composite articles and other applications.

### BACKGROUND OF THE INVENTION

Some alloys, such as superalloys, are different in properties from other alloys, such as refractory alloys, which leads to incompatibility. For example, Ni-based alloys are thermodynamically incompatible with Nb-based alloys, thereby complicating the welding or additive manufacturing (AM) of these two types of alloys. The same is also true even for pure Ni to pure Nb. Thus, the direct transition from certain Ni-based alloys to certain Nb-based alloys is not possible, and attempts to due so lead to spallation and/or cracks. Functionally graded transitions from a Ni-based alloy to a Nb-based alloy (e.g., pure Ni-based alloy to 80% Ni-based alloy/20% Nb-based alloy to pure Nb-based alloy) also lead to defects. Localized cracks may appear in the blended portion, and phases far from equilibrium may form during fabrication of the graded chemistry. Therefore, a need exists for an improved method of joining two dissimilar alloys, and for composite articles formed by joining two dissimilar alloys such as Ni-based alloys and Nb-based alloys.

### SUMMARY OF THE INVENTION

A composite article formed by joining two dissimilar alloys using a transition material of different composition is provided. The composite article includes a first portion comprising a first alloy having a first composition, and a second portion comprising a second alloy having a second composition. The second composition is different than the first composition. A transition portion joins the first portion to the second portion. The transition portion comprises a transition material having a composition that is different than both the first composition of the first alloy and the second composition of the second alloy.

In specific embodiments, the transition portion is sandwiched between the first portion and the second portion.

In specific embodiments, the transition portion does not include either of the first alloy or the second alloy as a component.

In particular embodiments, the transition portion only includes the transition material.

In specific embodiments, the transition portion includes a compositional gradient. The compositional gradient includes one or both of: a continuous compositional variation from the first alloy of the first portion to blends of the first alloy and the transition material wherein a ratio of the first alloy to the transition material decreases in a direction from the first portion towards the transition portion; and a continuous compositional variation from the second alloy of the second portion to blends of the second alloy and the transition material wherein a ratio of the second alloy to the transition material decreases in a direction from the second portion towards the transition portion.

In particular embodiments, the continuous compositional variation of the blends of the first alloy and transition material is a linear variation or non-linear variation, and the continuous compositional variation of blends of the second alloy and transition material is a linear variation or non-linear variation.

In specific embodiments, the first alloy is a high-strength material, and the second alloy is an extreme-temperature material.

In specific embodiments, the first alloy is a Ni-based superalloy, and the second alloy is a Nb-based refractory alloy, or conversely, the first alloy is a Nb-based refractory alloy and the second alloy is a Ni-based superalloy.

In specific embodiments, the transition material is one of: (i) a Ti-based alloy; (ii) a refractory element; and (iii) a refractory-based alloy including high entropy alloys (RHEAs) other than a Nb-based alloy.

In particular embodiments, the transition material is one of a Ti64 alloy and elemental Mo.

In specific embodiments, the composite article is formed by additive manufacturing.

In specific embodiments, the additive manufacturing is a blown powder laser-based Directed Energy Deposition (DED) process.

A method of fabricating a composite article is also provided. The method includes providing a first alloy having a first composition and a second alloy having a second composition. The second composition is different than the first composition. The method next includes depositing a first portion comprising the first alloy. The method next includes depositing a transition portion on the first portion. The transition portion comprises a transition material having a composition that is different than both the first composition of the first alloy and the second composition of the second alloy. The method next includes depositing a second portion comprising the second alloy on the transition portion such that the transition portion is sandwiched between the first portion and the second portion in a build direction from the first portion through the transition portion to the second portion. The transition portion comprising the transition material joins the first portion comprising the first alloy to the second portion comprising the second alloy.

In specific embodiments, the step of depositing the transition portion includes depositing only the transition material on the first portion.

In particular embodiments, the transition portion is formed of only the transition material.

In specific embodiments, the step of depositing the transition portion includes one or both of: forming a compositional gradient by depositing, in the build direction, successive layers each including a blend of the first alloy and the transition material wherein a ratio of the first alloy to the transition material decreases in the build direction; and forming a compositional gradient by depositing, in the build direction, successive layers each including a blend of the second alloy and the transition material wherein a ratio of the second alloy to the transition material increases in the build direction.

In particular embodiments, the ratio of the first alloy to the transition material varies either linearly or non-linearly from layer to layer of the successive layers including blends of the first alloy and the transition material, and the ratio of the second alloy to the transition material varies either linearly or non-linearly from layer to layer of the successive layers including blends of the second alloy and the transition material.

In specific embodiments, the first alloy is one of a high-strength material and an extreme-temperature material, and the second alloy is the other of the high-strength material and the extreme-temperature material.

In particular embodiments, the high-strength material is a Ni-based superalloy, and the extreme-temperature material is a Nb-based refractory alloy.

In specific embodiments, the transition material is one of: a Ti-based alloy; a refractory element; and a refractory alloy other than a Nb-based alloy.

In specific embodiments, the transition material is one of a Ti64 alloy and elemental Mo.

In specific embodiments, the steps of depositing the first portion, depositing the transition portion, and depositing the second portion are performed by additive manufacturing.

In particular embodiments, the additive manufacturing is a blown powder laser-based Directed Energy Deposition (DED) process.

A method of joining two dissimilar alloys is also provided. The method first includes forming a first portion comprising a first alloy. The method next includes forming a transition portion on the first portion. The method next includes forming a second portion on the transition portion, the second portion comprising a second alloy. The transition portion is sandwiched between the first portion comprising the first alloy and the second portion comprising the second alloy, and the transition portion joins the first portion comprising the first alloy to the second portion comprising the second alloy. The first alloy is different than the second alloy, and the transition portion comprises a transition material that is different than both the first alloy and the second alloy.

In specific embodiments, the first alloy is a one of a Ni-based superalloy and a Nb-based refractory alloy, the second alloy is the other of the Ni-based superalloy and the Nb-based refractory alloy, and the transition material is one of a Ti-based alloy, a refractory element, and a refractory alloy other than a Nb-based alloy.

These and other features of the invention will be more fully understood and appreciated by reference to the description of the embodiments and the drawings.

### BRIEF DESCRIPTION OF THE DRAWINGS

FIG. 1 is a schematic illustration of a composite article in accordance with embodiments of the disclosure;

FIG. 2 is a schematic illustration of a composite article having a uniform transition portion in accordance with some embodiments of the disclosure;

FIG. 3 is a schematic illustration of a composite article having a non-uniform transition portion including compositional gradients in accordance with other embodiments of the disclosure;

FIG. 4 is a side view of a composite article formed by the fabrication method of joining two dissimilar alloys in accordance with embodiments of the disclosure; and

FIG. 5 is a side view of a composite article formed by the fabrication method of joining two dissimilar alloys in accordance with other embodiments of the disclosure.

### DETAILED DESCRIPTION OF THE CURRENT EMBODIMENTS

In one aspect, an improved composite article including two dissimilar alloys joined together is provided. Dissimilar alloys have different chemical compositions, different physical properties, different crystal structures/phases, and/or an incompatibility that hinders direct joining of the two alloys. The composite article includes a transition portion that joins the two dissimilar alloys, the transition portion including a transition material that is different than both the first and second alloys. The transition portion allows for the transition from one alloy to another alloy even when the two alloys are themselves non-weldable. The transition portion also avoids abrupt property transitions at dissimilar interfaces, alleviates residual stress across large structures and also provides an alternate solution for joining two non-weldable alloys. In addition to alleviating CTE (coefficient of thermal expansion)-driven thermal mismatch between different alloy systems, the transition portion may provide performance benefits for static, dynamic, and high-speed impact property response. Further, the transition portion aides to eliminate the weak link in dissimilar-alloy-welded parts, which is often the weld zone itself. In another aspect, an improved method of fabricating a composite article is provided. The method includes depositing a first portion including a first alloy, depositing a transition portion including a transition material, and depositing a second portion including a second alloy, the transition material having a composition that is different than both the composition of the first alloy and the composition of the second alloy. In yet another aspect, an improved method of joining two dissimilar alloys is provided. The composite article, method of fabricating the composite article, and method of joining two dissimilar alloys are discussed in greater detail below.

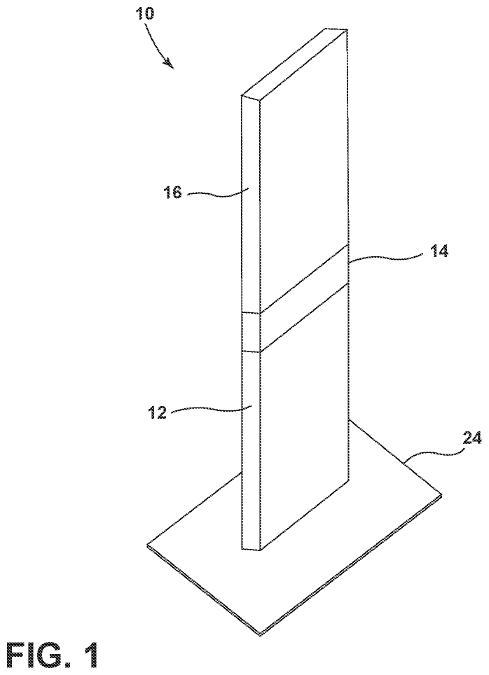

With reference to FIGS. 1-3, with like numerals indicating corresponding parts throughout the several views, a composite article 10 in accordance with embodiments of the disclosure includes a first portion 12, an intermediate transition portion 14, and a second portion 16. The transition portion 14 joins the first portion 12 to the second portion 16. As such, the transition portion 14 is interposed and sandwiched between the first portion 12 and the second portion 16 such that one end or side of the transition portion 14 is directly adjacent to the first portion 12, and the opposite end or side of the transition portion 14 is directly adjacent to the second portion 16. Also, first portion 12 contacts the transition portion 14, and the second portion 16 contacts the transition portion 14, but the first portion 12 does not contact the second portion 16. Further, the composite article 10 is continuous from the first portion 12 through the transition portion 14 to the second portion 16.

The first portion 12 includes a first alloy. In some embodiments, the first portion is composed entirely of the first alloy. In other embodiments, the first portion is composed of the first alloy but may also include other components, either as trace amounts/impurities or as specific additives. In either event, the first portion 12 may be composed primarily of the first alloy, and the first portion may have a uniform composition throughout such that there is no (appreciable) variation in composition throughout the first portion. The composition of the first alloy may be a high-strength material. One such high-strength material is a nickel-based (Ni-based) superalloy. Ni-based superalloys are high-performance alloys including a significant amount of nickel and having a high mechanical strength (e.g., high yield strength, such as 275 MPa, 500 MPa, 750 MPa, 1000 MPa, or higher) that is maintained even at high temperatures such as up to 1200° C. Ni-based superalloys thus may be used for high-speed and/or high-friction applications in which a significant amount of heat is generated. Other examples of suitable high-strength materials include Co-based superalloys and beta stabilized titanium (Ti) alloys.

The second portion 16 includes a second alloy. In some embodiments, the second portion is composed entirely of the second alloy. In other embodiments, the second portion is composed of the second alloy but may also include other components, either as trace amounts/impurities or as specific additives. In either event, the second portion 16 may be composed primarily of the second alloy, and the second portion may have a uniform composition throughout such that there is no (appreciable) variation in composition throughout the second portion. The composition of the second alloy is different than the composition of the first alloy, and the composition of the second alloy may be an extreme-temperature material. One such extreme-temperature material is a niobium-based (Nb-based) refractory alloy. Nb-based refractory alloys include a significant amount of niobium and can withstand extremely high temperatures such as up to 1300° C., optionally 1400° C., optionally 1500° C., optionally 1600° C., optionally 1650° C. Other examples of suitable extreme-temperature materials include molybdenum (Mo), tungsten (W), rhenium (Re) or tantalum (Ta) based refractory alloys and Refractory High Entropy Alloys (RHEA). The second alloy, as such, is dissimilar to the first alloy.

The transition portion 14 includes a transition material having a composition that is different than both the composition of the first alloy and the composition of the second alloy. The transition material may be, for example, a titanium-based (Ti-based) alloy such as, but not limited to, Ti64 (i.e., Ti-6Al-4V, which may have 88-100 wt. % Ti, 0-7 wt. % Al, 0-5 wt. % V), a refractory element such as, but not limited to, molybdenum (Mo), and also including elemental tantalum (Ta) and tungsten (W), or a refractory alloy other than a Nb-based alloy such as molybdenum (Mo), tungsten (W), rhenium (Re) or tantalum (Ta) based refractory alloys and Refractory High Entropy Alloys (RHEA). The transition material preferably has a high specific strength and/or high temperature capability. Thus, the transition portion can provide a high-temperature-capable zone (such as in the case of Mo) and/or a high-specific-strength zone (such as in the case of a Ti-based alloy). The transition portion advantageously allows for the joining of two dissimilar alloys (contained in the first and second portions 12, 16) that would otherwise not be joinable if they were built as contacting, directly adjacent portions.

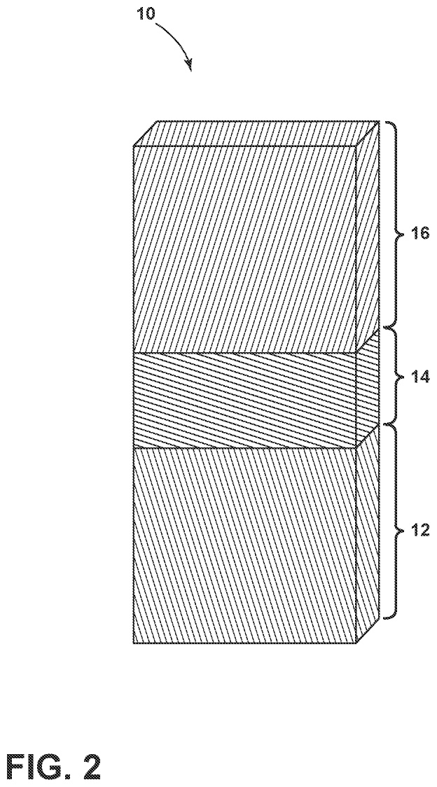

Turning to FIG. 2, in some embodiments the transition portion 14 does not include either of the first alloy or the second alloy as a component. In other words, the transition material constituting the transition portion 14 is neither the first alloy (portion 12) nor the second alloy (portion 16), and is also not a blend of a transition material with either of the first or second alloys. Stated differently, in these embodiments the transition portion is composed only of the transition material, the transition portion does not include either of the first and second alloys, and the transition material having a different composition than the composition of the first alloy and the composition of the second alloy. As such, the transition portion 14 is uniformly the transition material. Hence, in these embodiments, the first portion 12 including the first alloy is joined on one end to the transition material of the transition portion 14, and the second portion 16 including the second alloy is joined on the other end to the transition material of the transition portion 14, the transition portion 14 formed uniformly of the transition material thereby bridging the connection between the first portion 12 and the second portion 16.

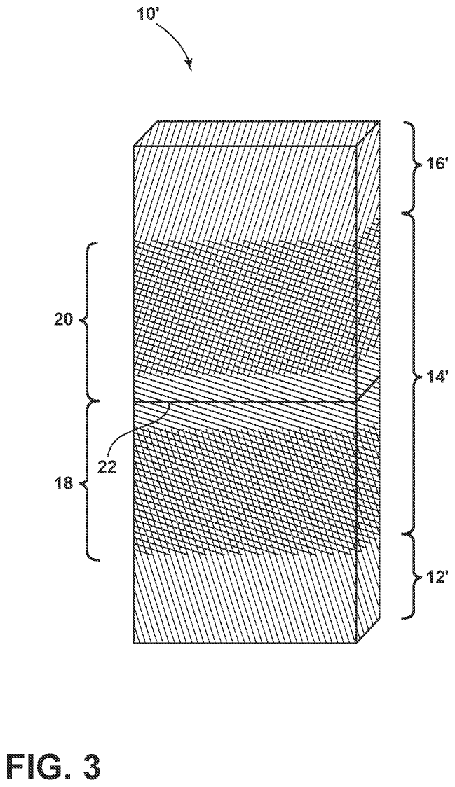

Turning next to FIG. 3, in other embodiments the transition portion 14′ of the composite article 10′ includes a compositional gradient (graded composition). A compositional gradient is a continuous composition variation/change from one material to another material with the blend (composition mixture/ratio) of the two materials changing without a gap or interruption in the direction of change. Thus, in the case of a decreasing content (e.g., mole %, wt. %, or the like) of component A in a direction of change, continuous means the content of component A in a mixture of components A and B continues to decrease in the direction of change, without going up and then back down, and without introduction of another component. It may be possible that the ratio of the mixture may stay constant for a section of the compositional gradient, but generally the ratio of A:B continues to decrease in the direction of change from one end to the other. Likewise, in the case of an increasing content of component A in a direction of change, continuous means the content of component A in a mixture of components A and B continues to increase in the direction of change, without going down and then back up, and without introduction of another component. It may be possible that the ratio of the mixture may stay constant for a section of the compositional gradient, but generally the ratio of A:B continues to increase in the direction of change from one end to the other. As shown in FIG. 3, the transition portion 14′ includes two adjoined compositional gradients 18, 20. The first composition gradient 18 begins at the end of the first portion 12′ at which the first portion meets the transition portion 14′. The first compositional gradient 18 includes a mixture/blend of the first alloy and the transition material. A ratio (e.g., mole ratio) R1 of first alloy to transitional material may be represented as A1:T. In the first compositional gradient 18, the ratio R1 continuously varies by decreasing in a direction from the first portion 12′ towards the transition portion 14′. In other words, in the direction from the first portion 12′ towards the transition portion 14′, the content of the first alloy relative to the content of transition material decreases, and oppositely the content of the transition material relative to the content of the first alloy increases. In certain embodiments, the variation is a linear (uniform) variation such that the rate of change of the ratio R1 is generally constant and/or even stepwise. For example, the first potion 12′ may be 100% first alloy, the compositional gradient 18 may vary such that in the direction from the first portion 12′ towards the transition portion 14′, the ratio R1 is first 80:20, then 60:40, then 40:60, then 20:80, then 0:100. Or by way of another example, the ratio R1 may vary from 99:1, to 98:2, to 97:3, to 96:4, and so on. Alternatively, in certain other embodiments, the variation is non-linear (non-uniform) such that the rate of change of the ratio R1 is not constant. For example, the compositional gradient 18 may vary such that in the direction from the first portion 12′ towards the transition portion 14′ the ratio R1 is 80:20, then 70:30, then 50:50, then 25:75, then 10:90, then 0:100. Or by way of another example, the ratio R1 may vary from 99:1, to 97:3, to 96:4, to 92:8, etc. In a likewise manner, the second compositional gradient 20 begins at the end of the second portion 16′ at which the second portion meets the transition portion 14′. The second compositional gradient 20 includes a mixture/blend of the second alloy and the transition material. A ratio (e.g., mole ratio) R2 of second alloy to transitional material may be represented as A2:T. In the second compositional gradient 20, the ratio R2 continuously varies by decreasing in a direction from the second portion 16′ towards the transition portion 14′. In other words, in the direction from the second portion 16′ towards the transition portion 14′, the content of the second alloy relative to the content of transition material decreases, and oppositely the content of the transition material relative to the content of the second alloy increases. In certain embodiments, the variation is a linear (uniform) variation such that the rate of change of the ratio R2 is generally constant and/or even stepwise. For example, the second potion 16′ may be 100% second alloy, the compositional gradient 20 may vary such that in the direction from the second portion 16′ towards the transition portion 14′, the ratio R2 is first 80:20, then 60:40, then 40:60, then 20:80, then 0:100. Or by way of another example, the ratio R2 may vary from 99:1, to 98:2, to 97:3, to 96:4, and so on. Alternatively, in certain other embodiments, the variation is non-linear (non-uniform) such that the rate of change of the ratio R2 is not constant. For example, the compositional gradient 20 may vary such that in the direction from the second portion 16′ towards the transition portion 14′ the ratio R2 is 80:20, then 70:30, then 50:50, then 25:75, then 10:90, then 0:100. Or by way of another example, the ratio R2 may vary from 99:1, to 97:3, to 96:4, to 92:8, etc. It should be understood that the second compositional gradient 20 alternatively could be said to begin at the end of the first compositional gradient 18 and progress towards the second portion 16′. In this regard, the description of the second composition gradient 20 would simply be reversed as it pertains to the variation in composition, i.e. the direction of change is reversed, and the content of second alloy A2 relative to transition material T increases in a direction from the first compositional gradient 18 towards the second portion 16.

In the embodiment shown in FIG. 3, there is a section 22 between the first compositional gradient 18 and the second compositional gradient 20 at which the content of transition material in the transition portion is 100%. In other words, in a direction from the first portion 12′ through the transition portion 14′ to the second portion 16′, the content of transition material increases in the first compositional gradient 18 from zero or near zero to 100% towards section 22, and then in the second compositional gradient 20 from 100% to zero or near zero towards portion 16′. Of course, the content of transition material in the first portion 12′ and the second portion 16′ adjacent to (at the joint of) the transition portion 14′ is zero. In alternative embodiments, however, it should be understood that the content of transition material in the transition portion 14′ between the first compositional gradient 18 and the second compositional gradient 20 may not be 100% transitional material. For example, in a direction from the first portion 12′ through the transition portion 14′ to the second portion 16′, the content of transition material may increase to 95% towards section 22 in the first compositional gradient 18 (i.e., in the first compositional gradient the ratio R1 (A1:T) decreases from 100:0 to 5:95), and then the content of the transition material may decrease from 95% to zero or near zero towards portion 16′ in the second composition gradient 20 in the stated direction (i.e., in the second compositional gradient the ratio R2 (A2:T) increases from 5:95 to 100:0). The adjoining end points of the first and second compositional gradients 18, 20 need not be 100% transition material. In other words, there need not be a section/layer of pure transition material between the first compositional gradient 18 and the second compositional gradient 20. Although such a section/layer of pure transition material may be preferable, the content of transition material at the junction of the first and second compositional gradients 18, 20 may instead be in a range of 95-99% transition material, by way of example.

Also, although the embodiment of the composite article 10′ shown in FIG. 3 includes both the first compositional gradient 18 and the second compositional gradient 20, it should be understood that the transition portion of the composite article may include only one of the two gradients, either the first compositional gradient (with varying content of first alloy and transition material) or the second compositional gradient (with varying content of second alloy and transition material). For example, the transition portion may include only the first compositional gradient, such that in a direction from the first portion through the transition portion to the second portion, the composition of the composite article varies in a gradient from 100% first alloy to 100% transition material, and a section of 100% transition material in the transition portion is joined to the second portion having 100% second alloy. Alternatively, the transition portion may include only the second compositional gradient, such that a section of 100% transition material in the transition portion is joined to the first portion having 100% first alloy, and in the transition portion the composition varies in a gradient from 100% transition material to 100% second alloy in a direction from the transition portion to the second portion.

A method of fabricating the composite article includes providing the first alloy having the first composition, providing the second alloy having the second composition, and providing the transition material having a composition different than both the first and second compositions. The method further includes first forming the first portion by depositing the first alloy on a substrate or other support surface 24 (as in FIG. 1), which may or may not be another portion of the composite article (i.e., the first portion, transition portion, and second portion may wholly make up the composite article, or themselves may only constitute a part of the composite article) or simply a surface on which the composite article is built. A build direction may be defined in a direction moving away from the substrate/support surface and in which successive layers of material are deposited. The method next includes forming the transition portion by depositing transition material (and also together with first and/or second alloy in the case of a compositional gradient), thereby forming the transition portion on the first portion. Particularly, in the case of a uniform transition portion, the transition portion is formed by depositing only the transition material (a layer or layers of transition material) on the first portion. Alternatively, in the case of compositional gradient(s) in the transition layer, the transition portion is formed by depositing successive layers each including a blend of the first alloy and transition material having a ratio of the first alloy to transition material that decreases in the build direction and/or by depositing successive layers each including a blend of second alloy and the transition material having a ratio of the second alloy to transition material that increases in the build direction. The method then includes forming the second portion by depositing the second alloy, the second portion being formed on the transition portion such that the transition portion is sandwiched between the first portion and the second portion in a build direction from the first portion through the transition portion to the second portion, and the transition portion joins the first portion to the second portion. The first portion, transition portion, and second portion have the same features as discussed above. It should be understood, however, that the first and second alloys may be interchanged (switched) such that the second alloy is used to first form the first portion, and the first alloy is last used to form the second portion. In other words, the order of deposition of the first and second alloys is not significant and may be switched, reversed, interchanged. The significant feature is the transition portion (including a material different than the first and second alloys) joins one portion (which may be the first alloy or the second alloy) to another portion (which is the other of the first and second alloys). The use of “first” and “second” as it pertains to the alloys is merely to distinguish one from the other, and is not meant to imply that the first portion necessarily must be formed with the first alloy or that the second portion must be formed with the second alloy. In the build direction, the first portion is formed before the second portion, but again, the first portion could be comprised of the second alloy and the second portion could be comprised of the first alloy.

The steps of the method may be performed by additive manufacturing (AM), and by way of specific example, the additive manufacturing may be a blown powder laser-based Directed Energy Deposition (DED) process. The DED process may include a high-powered laser and a coaxial nozzle. The build materials (e.g., first alloy, second alloy, transition material) are provided in powder form, fluidized in argon gas, and delivered to the coaxial nozzle that allows one, two, or more types of powder to flow either alone or simultaneously. The laser creates a weld/melt pool that melts the powder, and the nozzle moves in a three-dimensional pattern to build the article layer-by-layer as a powder jet of material(s) are jetted from the coaxial nozzle and melted by the laser. The flow rate of the powder materials dictates the mixing (grading) of the materials. DED processes are known in the art and will not be discussed in any greater detail.

### Examples

The present method is further described in connection with the following laboratory examples, which are intended to be non-limiting.

The following materials were used. IN718 having a powder size distribution of 45 to 106 μm was obtained from Oerlikon Metco as the Ni-based alloy. C103 having a powder size distribution of 45 to 105 μm was obtained from HC Starck as the Nb-based alloy. Ti64 alloy having a powder size distribution of 45 to 105 μm was obtained from Tekna as a transition material. Elemental Mo having a powder size distribution of 45 to 90 μm was obtained from Tekna as an alternative transition material.

The following process parameters were used for additive manufacturing by blown powder laser-based Directed Energy Deposition (DED).

TABLE 1
Build Parameters for Example 1

| AM Parameter | IN718 | Ti64 | C103 |
|---|---|---|---|
| Laser Power (Watts) | 300-385 | 280-300 | 350-550 |
| Tool Velocity (mm/min) | 1300-2250 | 2000-2250 | 1300-2250 |
| Powder Flow Rate (g/min) | 3.0-5.0 | 3.5-4.5 | 3.0-5.0 |
| Programmed Layer Height (mm) | 0.2-0.4 | 0.15-0.25 | 0.1-0.2 |
| Beam Diameter (mm) | 0.65-0.75 | 0.65-0.76 | 0.65-0.77 |
| Hatch Spacing (mm) | 0.3-0.4 | 0.3-0.4 | 0.3-0.4 |
| Nozzle Offset (mm) | 2.5-4.5 | 2.5-4.5 | 2.5-4.5 |
| O2 Environment (ppm) | 2.0-8.0 | 2.0-8.0 | 2.0-8.0 |
| Layer Count | 20.0-50.0 | 15.0-25.0 | 15.0-25.0 |

TABLE 2
Build Parameters for Example 2

| AM Parameter | IN718 | Mo | C103 |
|---|---|---|---|
| Laser Power (Watts) | 300-385 | 300-400 | 350-550 |
| Tool Velocity (mm/min) | 1300-2250 | 1300-2000 | 1300-2250 |
| Powder Flow Rate (g/min) | 3.0-5.0 | 2.5-5.0 | 3.0-5.0 |
| Programmed Layer Height (mm) | 0.2-0.4 | 0.15-0.25 | 0.1-0.2 |
| Beam Diameter (mm) | 0.65-0.79 | 0.65-0.80 | 0.65-0.81 |
| Hatch Spacing (mm) | 0.3-0.4 | 0.3-0.4 | 0.3-0.4 |
| Nozzle Offset (mm) | 2.5-4.5 | 2.5-4.5 | 2.5-4.5 |
| O2 Environment (ppm) | 2.0-8.0 | 2.0-8.0 | 2.0-8.0 |
| Layer Count | 20.0-50.0 | 6.0-10.0 | 1.0-60.0 |

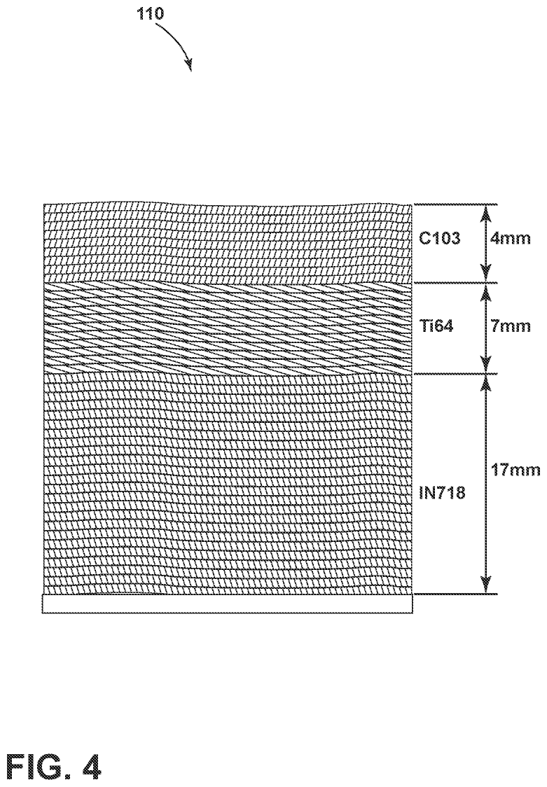

A schematic illustration of a composite article 110 according to Example 1 is shown in FIG. 4. The composite article of Example 1 was formed by blown powder laser-based DED within the parameters in Table 1 above and included a first portion formed of IN718, a second portion formed of C103, and a transition portion uniformly formed of Ti64. The thickness of the composite article in a direction transverse to the build direction was approximately less than or equal to 2 mm, and a length of each layer was in the range of approximately 20 to 25 mm. The Ti64 alloy of the transition portion successfully joined the IN718 first portion to the C103 second portion, whereas IN718 cannot be successfully joined directly to C103.

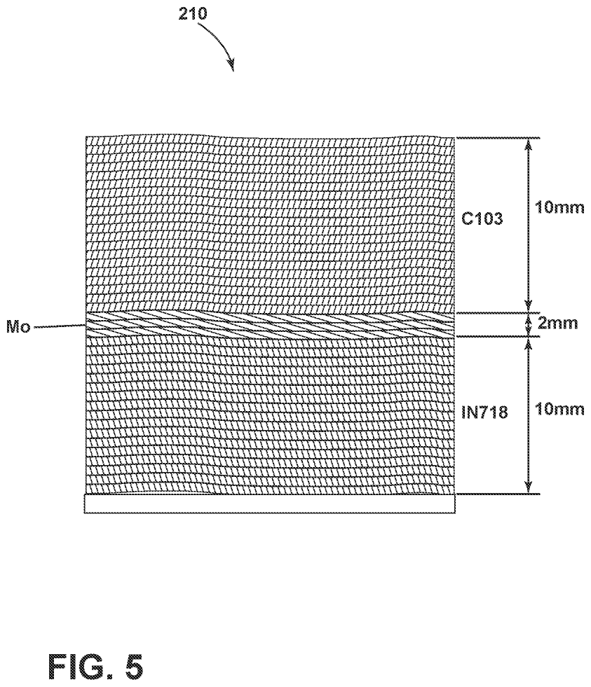

A schematic illustration of a composite article 210 according to Example 2 is shown in FIG. 5. The composite article of Example 2 was formed by blown powder laser-based DED within the parameters in Table 2 above and included a first portion formed of IN718, a second portion formed of C103, and a transition portion uniformly formed of elemental Mo. The thickness of the composite article in a direction transverse to the build direction was approximately less than or equal to 2 mm, and a length of each layer was in the range of approximately 20 to 25 mm. The elemental Mo of the transition portion successfully joined the IN718 first portion to the C103 second portion, whereas IN718 cannot be successfully joined directly to C103.

Analysis of both Example 1 and Example 2 revealed no delamination, no visual cracking, and coherent inter-compositional transitions.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A composite article comprising:
a first portion comprising a first alloy having a first composition;
a second portion comprising a second alloy having a second composition, wherein the second composition is different than the first composition;
a transition portion joining the first portion to the second portion;
wherein the transition portion comprises a transition material having a composition that is different than both the first composition of the first alloy and the second composition of the second alloy.

2. The composite article of claim 1, wherein the transition portion is sandwiched between the first portion and the second portion.

3. The composite article of claim 1, wherein the transition portion does not include either of the first alloy or the second alloy as a component.

4. The composite article of claim 3, wherein the transition portion only includes the transition material.

5. The composite article of claim 1, wherein the transition portion comprises a compositional gradient, the compositional gradient including one or both of: (i) a continuous compositional variation from the first alloy of the first portion to blends of the first alloy and the transition material wherein a ratio of the first alloy to the transition material decreases in a direction from the first portion towards the transition portion; and (ii) a continuous compositional variation from the second alloy of the second portion to blends of the second alloy and the transition material wherein a ratio of the second alloy to the transition material decreases in a direction from the second portion towards the transition portion.

6. The composite article of claim 5, wherein: (i) the continuous compositional variation of blends of the first alloy and transition material is a linear variation or non-linear variation; (ii) the continuous compositional variation of blends of the second alloy and transition material is a linear variation or non-linear variation; or (iii) both (i) and (ii).

7. The composite article of claim 1, wherein the first alloy is a high-strength material, and the second alloy is an extreme-temperature material.

8. The composite article of claim 1, wherein the first alloy is a Ni-based superalloy, and the second alloy is a Nb-based refractory alloy.

9. The composite article of claim 1, wherein the transition material is one of: (i) a Ti-based alloy; (ii) a refractory element; and (iii) a refractory alloy other than a Nb-based alloy.

10. The composite article of claim 9, wherein the transition material is one of a Ti64 alloy and elemental Mo.

11. The composite article of claim 1, wherein the composite article is formed by additive manufacturing.

12. The composite article of claim 11, wherein the additive manufacturing is a blown powder laser-based Directed Energy Deposition (DED) process.

13. A method of fabricating a composite article, the method comprising:
providing a first alloy having a first composition and a second alloy having a second composition, wherein the second composition is different than the first composition;
depositing a first portion comprising the first alloy;
depositing a transition portion on the first portion, the transition portion comprising a transition material having a composition that is different than both the first composition of the first alloy and the second composition of the second alloy; and
depositing a second portion comprising the second alloy on the transition portion such that the transition portion is sandwiched between the first portion and the second portion in a build direction from the first portion through the transition portion to the second portion;
whereby the transition portion comprising the transition material joins the first portion comprising the first alloy to the second portion comprising the second alloy.

14. The method of claim 13, wherein the step of depositing the transition portion includes depositing only the transition material on the first portion.

15. The method of claim 14, wherein the transition portion is formed of only the transition material.

16. The method of claim 13, wherein the step of depositing the transition portion includes one or both of: (i) forming a compositional gradient by depositing, in the build direction, successive layers each including a blend of the first alloy and the transition material wherein a ratio of the first alloy to the transition material decreases in the build direction; and (ii) forming a compositional gradient by depositing, in the build direction, successive layers each including a blend of the second alloy and the transition material wherein a ratio of the second alloy to the transition material increases in the build direction.

17. The method of claim 16, wherein: (i) the ratio of the first alloy to the transition material varies either linearly or non-linearly from layer to layer of the successive layers including blends of the first alloy and the transition material; (ii) the ratio of the second alloy to the transition material varies either linearly or non-linearly from layer to layer of the successive layers including blends of the second alloy and the transition material; or (iii) both (i) and (ii).

18. The method of claim 13, wherein the first alloy is one of a high-strength material and an extreme-temperature material, and the second alloy is the other of the high-strength material and the extreme-temperature material.

19. The method of claim 18, wherein the high-strength material is a Ni-based superalloy, and the extreme-temperature material is a Nb-based refractory alloy.

20. The method of claim 13, wherein the transition material is one of: (i) a Ti-based alloy; (ii) a refractory element; and (iii) a refractory alloy other than a Nb-based alloy.

21. The method of claim 13, wherein the transition material is one of a Ti64 alloy and elemental Mo.

22. The method of claim 13, wherein the steps of depositing the first portion, depositing the transition portion, and depositing the second portion are performed by additive manufacturing.

23. The method of claim 22, wherein the additive manufacturing is a blown powder laser-based Directed Energy Deposition (DED) process.

24. A method of joining two dissimilar alloys, the method comprising:
forming a first portion comprising a first alloy;
forming a transition portion on the first portion; and
forming a second portion on the transition portion, the second portion comprising a second alloy;
wherein the transition portion is sandwiched between the first portion comprising the first alloy and the second portion comprising the second alloy;
wherein the transition portion joins the first portion comprising the first alloy to the second portion comprising the second alloy;
wherein the first alloy is different than the second alloy, and the transition portion comprises a transition material that is different than both the first alloy and the second alloy.

25. The method of claim 24, wherein:
the first alloy is a one of a Ni-based superalloy and a Nb-based refractory alloy;
the second alloy is the other of the Ni-based superally and the Nb-based refractory alloy; and
the transition material is one of: (i) a Ti-based alloy; (ii) a refractory element; and (iii) a refractory alloy other than a Nb-based alloy.
